(19) United States
(12) Patent Application Publication
(10) Pub. No.: US 2010/0049106 A1
(43) Pub. Date: Feb. 25, 2010

(54) MASSAGE DEVICES

(75) Inventor: Jean-Louis Gueret, Paris (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: L'OREAL, Paris (FR)

(21) Appl. No.: 12/511,163

(22) Filed: Jul. 29, 2009

(30) Foreign Application Priority Data
Jul. 30, 2008 (FR) 08 55264

(51) Int. Cl. A61H 15/00

(52) U.S. Cl. 601/112

(57) ABSTRACT

The present invention relates to a massage device including at least one rotary massage system (3), the device comprising:
a support (2) including two mounting pieces (6); and
two massage members (10) mounted on said support and each turning relative to the support (2) about an axis of rotation (X, X′) defined by a shaft (15), each mounting piece (6) supporting the shaft (15) associated with the corresponding massage member, the slope of the axes of rotation (X, X′) relative to the mounting pieces (6) depending on the position of an intermediate part (20) that is movable relative to the support (2), said intermediate part being situated between the massage members (10) and being connected to the shaft (15) associated with each massage member.

This non provisional application claims the benefit of French Application No. 08 55264 filed on Jul. 30, 2008.

### BACKGROUND OF THE INVENTION

US 2007/0083135 A1 discloses a massage device including two rotary massage members that are carried by flexible branches.

EP 1 774 950 discloses another massage device including massage members each having at least one pair of flexible lips.

Massage devices including rollers are described in FR 1 093 828, FR 2 480 118, FR 2 854 312, GB 880 289, and GB 519 875.

EP 1 472 953 A1 discloses a massage device including two massage rollers each mounted on a fork, with an adjuster system for adjusting the orientation of one fork relative to the other. Such a device is of relatively complex structure and requires the forks to be made in such a manner as to withstand relatively large mechanical forces on the adjuster system.

FR 2 664 158 also describes support forks for supporting the massage rollers.

FR 2 919 493 provides a massage device that is arranged to deform in response to pressure exerted on a region being treated.

### OBJECT AND BRIEF SUMMARY OF THE INVENTION

There exists a need to improve massage devices still further, in particular so as to make it easy for the user to perform various types of massage.

Depending on the desired purpose, e.g. lymphatic drainage or stimulating circulation in order to favor penetration of active ingredients, massage should be energetic to a greater or a lesser extent.

Exemplary embodiments of the invention provide a massage device including at least one rotary massage system, the device comprising:
a support including two mounting pieces; and
two massage members mounted on said support and each turning relative to the support about an axis of rotation defined by a shaft, each mounting piece supporting the shaft associated with the corresponding massage member, the slope of the axes of rotation relative to the mounting pieces depending on the position of an intermediate part that is movable relative to the support, said intermediate part being situated between the massage members and being connected to the shaft associated with each massage member.

The mounting pieces may have longitudinal axes that are parallel to the longitudinal axis of the whole device. The two mounting pieces may be two uprights.

By means of the invention, the user may easily modify the configuration of the massage system relative to the surface being treated, and may thus perform various different types of massage.

By way of example, the user may adjust the position of the intermediate part relative to the support before starting massaging. The adjustment may be independent of the pressure exerted by the massage members on the region being treated.

The user may vary the slope of the massage members, e.g. reduce the slope to zero. The slope of the massage members may be modified within a plane, or even outside a plane, depending on the means used to modify the slope.

The slope of the massage members may be modified in such a manner as to create a large angle between the axes of rotation, and to achieve a massaging action (e.g. pinching and rolling) effect in order to drain the epidermis. When the slope is zero, and when the massage members turn about the same axis of rotation, their entire surface extends flat, thereby making it possible to perform a different massage action, e.g. tapping of the skin in order to stimulate acupuncture points. In an intermediate position, the drainage effect may be reduced.

By way of example, the massage system includes a massage member that turns by means of a support shaft having one end that is carried by the intermediate part (also called the bearing), and said intermediate part may be movable relative to the support against the action of a resilient return member.

The pressure exerted by the massage members on the region being treated may modify the configuration of the massage system, e.g. around the position adjusted by the user before starting massaging.

By way of example, greater pressure may lead to a reduction in the angle between the axes of rotation of the massage members.

By way of example, the intermediate part may be situated in a mid-plane between the two massage members.

The intermediate part may also be moved relative to the support in response to the actuation of an adjuster member that is movable relative to the support, for example.

The intermediate part may not turn relative to the support.

In variant exemplary embodiments, the intermediate part includes a thread and the adjuster member comprises a knurled knob that is mounted to turn on the support, such that turning the knob causes the intermediate part to move.

The intermediate part may be movable in a first direction contained in a plane defined by the axes of rotation of the massage members. The first direction may be parallel or perpendicular to a longitudinal axis of the device. The intermediate part may also be movable in a second direction that is generally perpendicular to the first, e.g. when the user acts on a corresponding additional adjuster member. That makes it possible to modify not only the angle formed between the massage members facing the region being treated, but also the angle formed facing forwards or rearwards relative to the direction of movement of the device over the region being treated.

The intermediate part may be movable relative to a handle portion in response to an action by the user.

In a variant of the invention, the support may be movable relative to the handle portion in response to an action by the user, the intermediate part being stationary relative to the handle portion. For example, the device may include a guide portion on which the support may be slidably mounted. The guide portion may be stationary relative to the intermediate part.

The support may slide freely over the guide portion, and the user may select a position for the support relative to the guide portion, in order to create the desired slope between the axes X and X′ of the massage members, and hold the support in that position. In a variant, the device may include at least one locking means making it possible to lock the support in position relative to the guide portion.

By way of example, the guide portion may include notches, ridges, portions in relief, grooves, holes, or any other means that may co-operate with a latch on the support, or vice versa. The user may thus block the support in the desired position, then change the position by acting on the latch so as to unblock it.

Both mounting pieces may be made together as a one-piece molding.

The mounting pieces may thus be made integrally with a base by molding thermoplastic material, said base possibly being used for fastening on a container, for example.

The base may include an end wall that extends between the two mounting pieces, e.g. an end wall in the shape of a plate that is substantially perpendicular to the mounting pieces.

The angle between the axes of rotation of the massage members may vary by at least 20° because of the movement of the intermediate part relative to the support.

The intermediate part may be connected to the support other than merely by the shaft of each massage member. The intermediate part and the support are movable relative to each other in predefined and guided manner.

The support may be connected in stationary manner to a handle portion of the massage device. The support may be made integrally with the handle portion by molding thermoplastic material.

In a variant, the intermediate part may be connected in stationary manner to a handle portion. The intermediate part may be made integrally with the handle portion by molding thermoplastic material.

The device may optionally include a container containing a composition for application to the skin, before, during, or after the massage.

The container may define the handle portion at least in part.

The massage system may be disposed laterally relative to the handle portion.

At least one of the massage members may be mounted on a telescopic shaft.

The massage system may include at least two massage members turning on the same flexible support shaft that is a single part or that comprises support-shaft segments that are hinged together.

By way of example, the massage members are rollers that may optionally be elastically-deformable. When the rollers are elastically deformable, said rollers may accompany the deformation of the corresponding support shaft, where appropriate. The rollers may be made of elastomer, at least in part.

The massage system, in particular the massage members that it includes, e.g. the above-mentioned rollers, may include massage portions in relief that may be of various shapes. The orientation of the massage portions in relief is likely to vary during the massage operation.

The massage portions in relief may optionally be distributed over the entire length of the massage system, and they may be identical or different.

The massage member(s) may include portions in relief that are integrally molded therewith or that are added thereto.

By way of example, the portions in relief comprise ribs that, in cross section, may present an outline that is circular or non-circular, in particular polygonal. A non-circular outline makes it possible to vary the pressure applied during turning.

For a polygonal outline, the massage system may include ribs having polygonal outlines that are angularly offset in alternation, for example.

Alternatively, the portions in relief may include spikes that may optionally be angularly offset when they are observed along the longitudinal axis of the massage member.

The portions in relief may comprise annular lips.

Alternatively, the portions in relief may comprise undulating ribs. The portions in relief may comprise a first set of ribs having a first orientation relative to the longitudinal axis of the massage system, and a second set of ribs having a second orientation relative to the longitudinal axis of the massage system, the first and second orientations being different, e.g. symmetrical about a mid-plane for the massage system. This makes it possible to create a pinching action (“plisse”) on the skin while the massage system is turning.

Any type of massage portion in relief profile may be used, including sequenced profiles, e.g. spiral or helical profiles.

The massage portions in relief may be made out of the same material as the body of a massage member, or they may be made out of a different material. A different material, in particular a harder material, may enable action to be stronger, but without that reducing the flexibility of the body which may itself be made out of a material that is more flexible.

By way of example, the length of each massage member is greater than or equal to 2 centimeters (cm).

By way of example, the maximum diameter D of a massage member is greater than or equal to 8 millimeters (mm), e.g. lying in the range 8 mm to 30 mm.

The massage system may be deformed in various ways relative to the base, e.g. by moving towards the end wall, by moving away from the end wall, or by moving rearwards relative to the end wall, e.g. in a direction that is generally perpendicular to a plane containing the longitudinal axes of the mounting pieces.

The support may be molded integrally with the body of the container, or it may be fitted on the body of the container.

The container may include at least one dispenser member and the massage device may be located on the opposite side from the dispenser member or beside said dispenser member. The container may be of aerosol type, or it may be provided with a pump, with a porous applicator, e.g. a foam or a sintered element, with an applicator roller or ball, or with any other known means for dispensing and/or applying the composition.

The support shaft of a massage member may possibly extend beyond the corresponding mounting piece of the support. Each support shaft end connected to a corresponding mounting piece may occupy a substantially constant position on the mounting piece.

The massage system may include a massage member that is not mounted to rotate on a support shaft that passes right through it, but rather has stub axles at its ends that may be made out of a material that is more rigid than the material of the massage member. In such an embodiment, and by way of example, the massage member is hollow and/or made out of a material that is not very rigid, so as to be able to flex in use, on contact with a non-plane surface of the region being treated. Where appropriate, the massage device may include at least one support shaft turning with at least one massage member, or a massage member including, at its ends, support stub axles that are made integrally with at least a portion of the massage member.

### BRIEF DESCRIPTION OF THE DRAWINGS

The invention can be better understood on reading the following detailed description of non-limiting embodiments thereof, and on examining the accompanying drawings, in which:

FIG. 1 is an elevation view of an example of a massage device made in accordance with the invention and shown in a working position;

FIG. 2 shows the FIG. 1 device in another working position of the massage system;

FIG. 3 is a diagrammatic and fragmentary exploded view of the massage device;

FIGS. 3a and 3b show variant embodiments of the intermediate part;

FIGS. 4 and 5 are elevation views showing a variant embodiment of the massage device;

FIG. 6 is a diagrammatic and fragmentary view showing a variant of the adjuster means;

FIG. 7 is an elevation view showing a variant of a massage device;

FIG. 8 is a fragmentary elevation view of a variant embodiment of the massage device;

FIG. 9 is a plan view showing the FIG. 8 device;

FIGS. 10 to 23 show variant embodiments of the massage members;

FIGS. 24 to 26 show variants of the massage devices;

FIGS. 27a to 27e show variants of mountings for a support shaft;

FIG. 28 shows a variant embodiment of the support shaft; and

FIGS. 29 and 30 show a variant embodiment of the massage system.

### MORE DETAILED DESCRIPTION

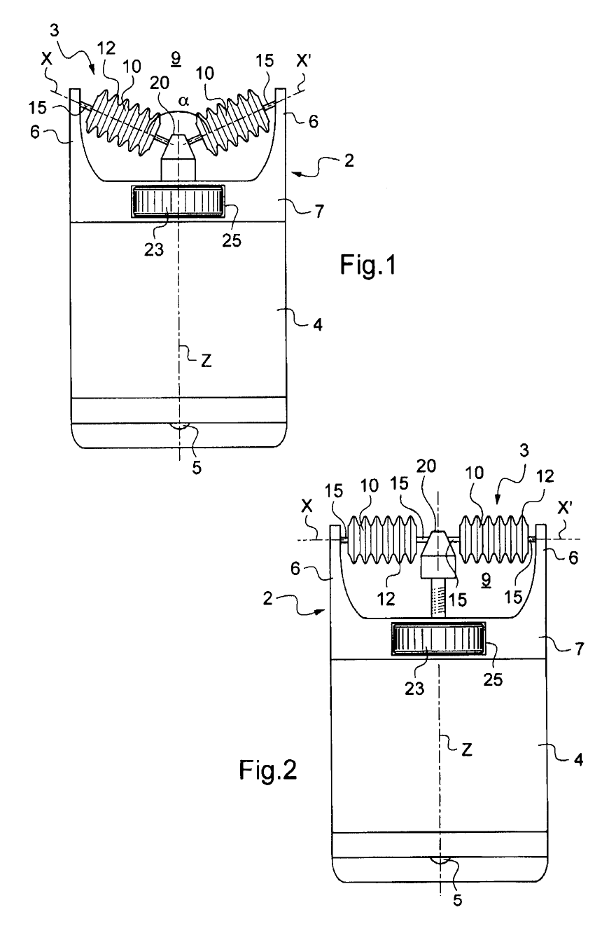

The massage device 1 shown in FIGS. 1 and 2 includes a support 2 and a massage system 3.

In the embodiment under consideration, the support 2 is secured to a container 4 that contains a composition that is suitable for being applied to the skin before, during, or after massaging. By way of example, the container 4 includes a composition dispenser system that may be of any type, and in the embodiment under consideration the container may be closed by a cover 5 present at the rear of the device 1, at its end remote from the massage system 3.

The dispenser system may include an endpiece, a foam, an applicator roller or ball, a pump, or any other known means for dispensing and/or applying the composition.

In the embodiment under consideration, the support 2 is stationary relative to the container 4, and, by way of example, includes a base 7 that is fastened by snap-fastening, or by some other means, on the container 4.

As in the embodiment shown, the container 4 may define the handle portion 201.

In a variant not shown, the support 2 is made integrally with at least part, if not all, of the container 4 by molding thermoplastic material.

In the embodiment under consideration, the support 2 includes two mounting pieces 6, e.g. of longitudinal axes that are parallel to the longitudinal axis of the container, forming between them a housing 9 in which there are disposed two massage members 10 belonging to the massage system 3. The massage members 10 that are in the form of rollers, for example, as shown, are for coming into engagement with the skin while the massage device is being used. The massage members 10 turn about respective axes of rotation X and X′.

In exemplary embodiments of the invention, the angle a between the axes X and X′ may be modified while the massage device is being used. In the embodiment under consideration, the massage members 10 are carried by support shafts 15 that are connected at their outer ends to corresponding mounting pieces 6, and at their inner ends to an intermediate part 20 that is movable relative to the support 2, the position of the intermediate part relative to the support 2 determining the slope a between the axes X and X′.

More precisely, in the embodiment under consideration, the intermediate part 20 may be moved by means of a mechanism on which the user acts, the mechanism comprising a knurled knob 23 that is suitable for turning relative to the support 2 about an axis of rotation, for example, its axis of rotation being parallel to, or even coinciding with, the longitudinal axis Z of the device 1.

The support 2 may include an opening 25 in which the knob 23 is engaged.

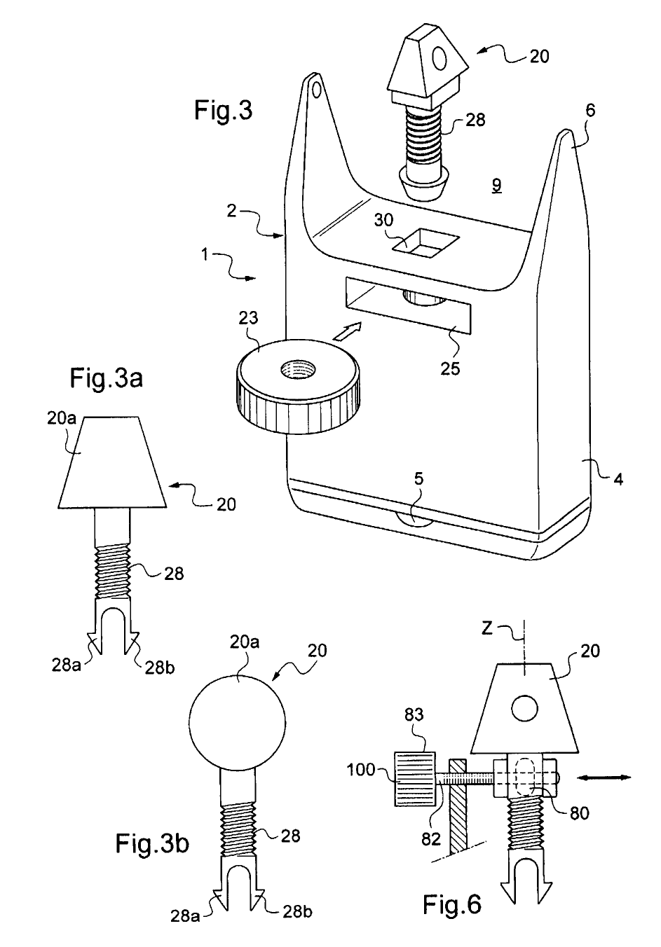

The intermediate part 20 may include a threaded rod 28 on which the knob 23 is screwed, as can be seen in FIG. 3, thereby making it possible for turning the knob 23 about the axis Z to be transformed into movement of the intermediate part 20 along the axis Z.

To avoid the intermediate part 20 turning relative to the support 2, the intermediate part 20 may co-operate with an opening 30 in the support, and of section that is non-circular, e.g. polygonal, in particular square as shown, so as to be able to move axially in the opening along the axis Z, without being able to turn about the axis Z.

The massage device 1 may be made in such a manner as to enable the slope a between the axes of rotation X and X′ to be varied as desired.

For example, as shown in FIG. 2, the stroke of the intermediate part 20 may be sufficient to be able to pass from a configuration in which the axes of rotation X and X′ coincide, and are perpendicular to the longitudinal axis Z of the device for example, to a configuration as shown in FIG. 1, in which the axes X and X′ form an angle α between them that is not equal to 180°.

By way of example, the maximum variation in the angle α for the device 1 is greater than or equal to 5° and less than or equal to 60°, preferably lying in the range 10° to 45°.

In the embodiment in FIGS. 1 to 3, the axes X and X′ remain in a single plane when the angle α varies, but this may be otherwise without going beyond the ambit of the invention.

The intermediate part 20 is advantageously provided with retaining means that make it possible to avoid it becoming detached from the device 1 when the adjuster knob 23 is turned fully. As shown in FIGS. 3a and 3b, the retaining means may be in the form of a slotted portion defining two elastically-deformable tabs 28a and 28b that are each provided with a tooth, the tabs being suitable for snap-fastening through the hole of the knob 23 while the intermediate part is being mounted on the support 2.

Various shapes may be given to the head 20a of the intermediate part 20 to which the support shafts are hinged, e.g. generally pyramid shaped as shown in FIG. 3a, or generally spherical as shown in FIG. 3b, or even any other appropriate shape.

The stroke of the intermediate part 20 along the axis Z between its extreme adjustment positions lies in the range 5 mm to 20 mm, for example.

Once the position of the intermediate part 20 has been adjusted, the friction between the threaded rod 28 of the intermediate part and the knob 23 prevents any significant movement of the intermediate part relative to the support 2, while the massage members 10 are being applied against the skin and while the device 1 is being moved in contact therewith.

Naturally, the embodiment in FIGS. 1 to 3 may be made with massage members presenting other shapes, in particular massage members such as those described below.

By way of example, in order to use the device in FIGS. 1 to 3, the user may apply the composition contained in the container 4 to the skin of the region of the body being treated, and may select the slope a between the axes X and X′ that is suited to the desired massage.

The configuration in FIG. 2 in which the axes X and X′ coincide make it possible to exert a massage that is lighter than with the configuration shown in FIG. 1.

Where appropriate, the container may include a plurality of compartments and a plurality of compositions, each composition corresponding to a particular adjustment of the slope between the rollers, for example.

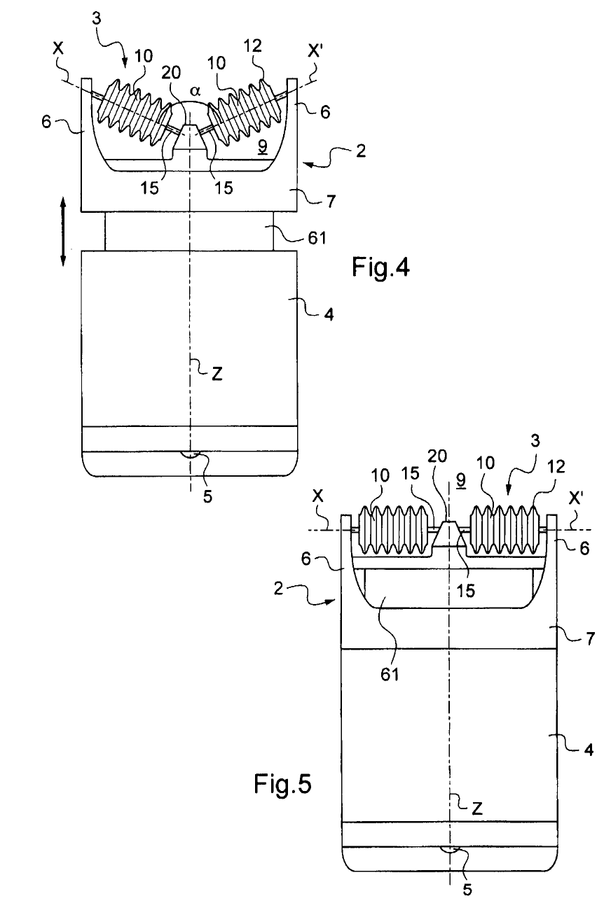

In the variant embodiment in FIGS. 4 and 5, the intermediate part 20 is stationary relative to the handle portion 201, and it is the support 2 that may be moved relative to the handle portion. In this embodiment, the handle portion is defined by a portion of the container 4.

By way of example, the support 2 is slidably mounted on a guide portion 61 that surmounts the container 4, but that may be made integrally therewith, where appropriate.

In the embodiment shown, the guide portion 61 includes an abutment-forming portion 62 that makes it possible to avoid the support 2 detaching from the device 1.

The support 2 may slide freely over the guide portion 61, and the user may hold the support 2 in the position, relative to the guide portion 61, that provides the desired slope between the axes X and X′.

However, as in the embodiment shown, locking means for locking the support 2 in position relative to the guide portion 61 may advantageously be used.

For example, notches 63 may be formed in the guide portion 61, and the support 2 may include a latch 64 that may co-operate with one of the notches, so as to block the support 2 in the desired position. The user may change the position by pressing on the latch 64 in such a manner as to unblock it.

In another variant not shown, the guide portion 61 includes ridges, portions in relief, grooves, or holes that are capable of co-operating with a latch 64 on the support 2.

In another variant, the guide portion 61 includes a latch 64, and the support 2 includes notches, ridges, portions in relief, grooves, or holes 63 that are capable of co-operating with the latch 64.

The massage system 3 may be oriented in many ways relative to the container 4, and in particular relative to the surface of the device 1 that serves as a handle for using the device and for moving the massage members 10 over the skin.

In the embodiments in FIGS. 1 to 5, the massage system 3 is at a longitudinal end of the device 1.

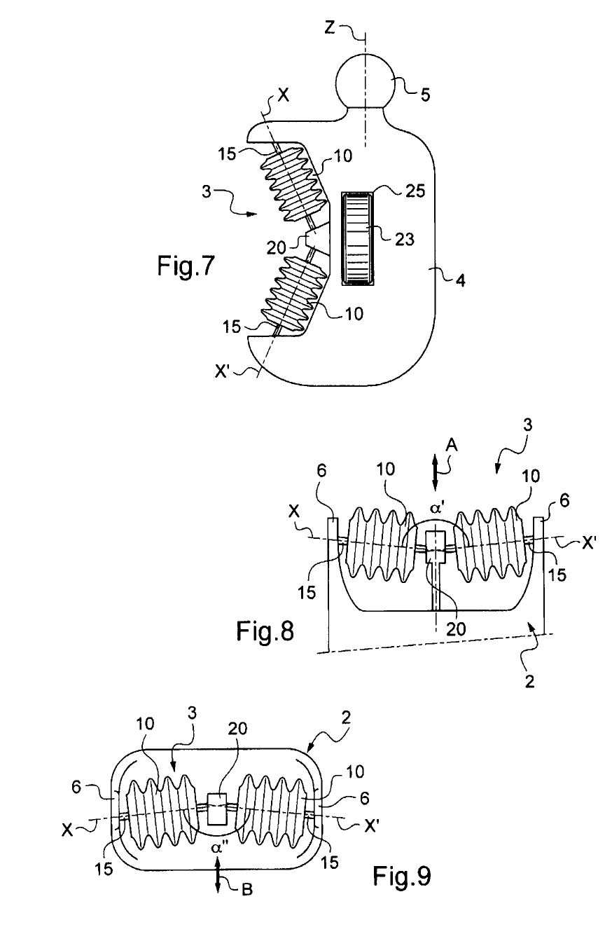

In the embodiment in FIG. 7, the massage system is situated on the side of the container 4.

FIGS. 8 and 9 show the possibility of making the massage device in such a manner that the intermediate part 20 moves relative to the support 2 not only along one axis, but along at least two axes, e.g. that are perpendicular to each other. This makes it possible to vary the slope between the axes of rotation X and X′ not only so as to have an angle α′ that is open to a greater or lesser extent towards the top end of the device when the intermediate part moves vertically along arrow A, as shown in FIG. 8, but also so as to have an angle α″ that varies rearwards along arrow B when the intermediate part 20 moves in a plane that is perpendicular to the longitudinal axis Z of the device, as shown in FIG. 9.

In order to vary the angle in a plane that is perpendicular to the longitudinal axis of the device, it is possible for example to use an additional adjuster means 100, as shown in FIG. 6, that is engaged with the intermediate part 20 and also with the support.

In the embodiment shown in FIG. 6, the intermediate part 20 includes an opening 80 that is tall enough to accommodate the desired axial stroke along the axis Z of the intermediate part 20, when the user acts on the adjuster knob 23. A rod 82 of the additional adjuster means 100 passes through the opening 80, and, by being moved longitudinally, said rod 82 may drive the intermediate part 20 rearwards, at least over a short distance, when the user turns an adjuster button 83.

The massage members 10 may optionally be elastically deformable.

In various examples, the massage members 10 are in the form of two rollers that are provided with massage portions in relief 12 at their peripheries. By way of example, the massage portions in relief 12 are made in the form of annular ribs that are of constant height and evenly spaced, but the invention is not limited to this example of massage portions in relief 12, which portions may be different, e.g. as described below.

By way of example, each massage member 10 is made out of an elastomer material, e.g. an elastomer material of Shore A hardness lying in the range 20 to 90, e.g. a material selected from: polyolefins, in particular polypropylene (PP), polyethylene (PE); nitrile rubbers; silicones; styrene-ethylene-butylene-styrene (SEBS); thermoplastic elastomers, e.g. Hytrel®, Pebax®; polyurethane (PU); polyvinyl chloride (PVC); ethyl vinyl acetate (EVA).

When a massage member 10 includes annular ribs, the cross-section of said ribs may present an outline that is circular or non-circular, e.g. polygonal.

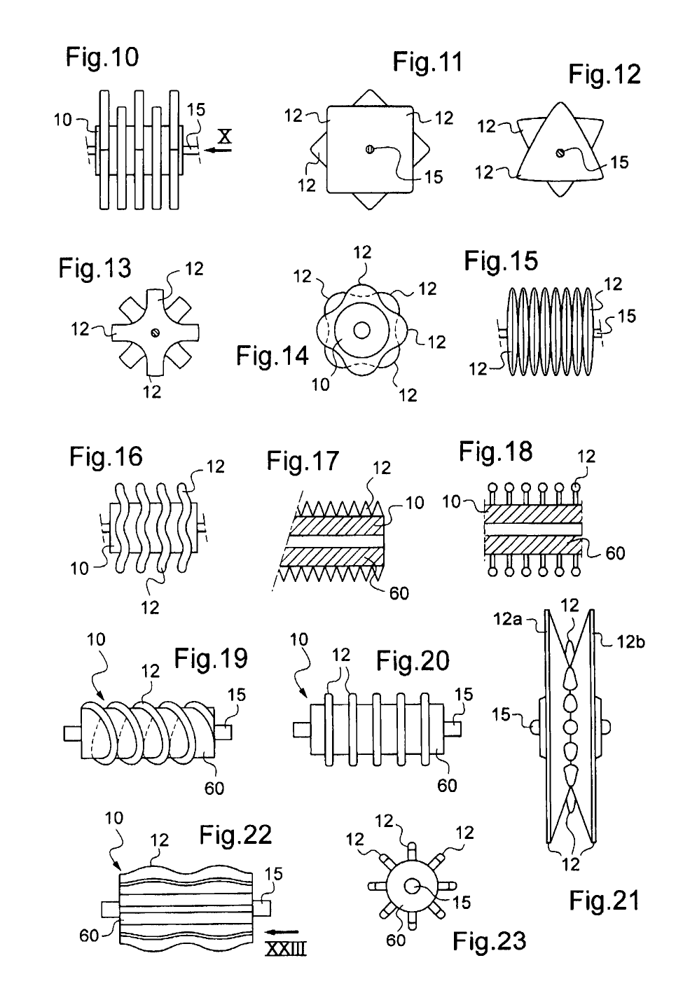

By way of example, FIGS. 10 and 11 show ribs having an outline that is polygonal, specifically square, the ribs being angularly offset in alternation.

In the embodiment in FIG. 12, the outline of the ribs is substantially triangular, said ribs also being offset in alternation along the longitudinal axis of the massage member.

In the embodiment in FIG. 13, the massage portions in relief are spikes, e.g. being offset in alternation along the longitudinal axis of the massage member. The spikes may optionally be the same height on moving over a succession of spikes in the same position about the longitudinal axis of the massage member.

Alternatively, the massage system may include massage members in the form of disks that are disposed side by side on the support shaft 15, as shown in FIG. 15.

Alternatively, the massage portions in relief may be in the form of undulating ribs, i.e. each having a periphery that occupies an axial position that varies along the longitudinal axis of the massage member, as a function of position about the longitudinal axis, as shown in FIG. 16.

In a variant in FIG. 20, the ribs do not present undulations.

As shown in FIG. 17, a massage member 10 may include a body 60 having a hollow cylinder shape made out of an elastomer material, and by way of example, the massage portions in relief 12 are fitted on the body 60, e.g. being made out of a material of the same hardness as the body 60 or out of a material that presents a different hardness, in particular greater hardness. By way of example, the massage portions in relief 12 comprise ribs or spikes fitted on the body 60. The massage portions in relief 12 may be fitted by any means on the body 60, e.g. by adhesive, by snap-fastening, or by welding.

Alternatively, the massage portions in relief 12 may be made by being molded onto the body 60, e.g. out of a harder material.

In the embodiment in FIG. 18, the massage portions in relief 12 are made in the shape of spikes with wide rounded heads, and other shapes are naturally possible.

FIG. 19 shows massage portions in relief having the shape of a helical rib.

In the embodiment in FIG. 21, the massage member includes two thin annular lips 12a and 12b that present a series of spikes 12c between them.

FIGS. 22 and 23 show a variant of massage portions in relief including ribs in the axial direction of the massage member.

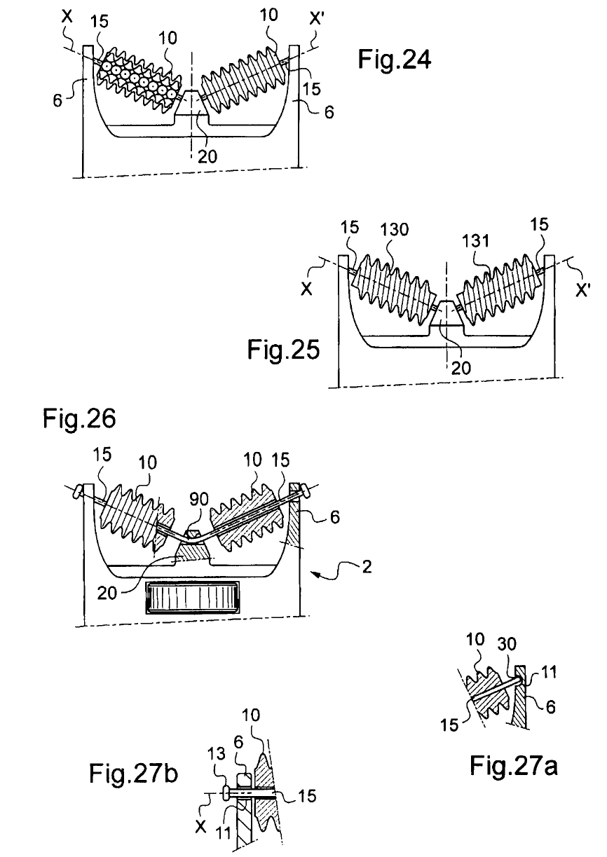

The two massage members that are mounted on the massage device may be identical or different, as shown in FIG. 24.

As shown in FIG. 25, the massage members may include ribs that slope relative to the axis of rotation, the massage members optionally being symmetrical about a longitudinal mid-plane of the device, for example.

The support shafts of the massage rollers may be separate from each other, or, in a variant, as shown in FIG. 26, they may be made as a single part, being interconnected via a flexible hinge-forming portion 90 that can be moved by the intermediate part 20 relative to the support 2. By way of example, this preferred flexible deformation portion is obtained by a change in the section and/or in the material of the support shaft, e.g. mid-way along said support shaft.

The support shafts 15 may be connected in various ways to the mounting pieces 6 and to the intermediate part 20, e.g. mounted in hinged manner on the mounting pieces 6 and the intermediate part 20. The ends of the support shafts 15 may be mounted with a possibility of movement relative to the support 2.

The end of a support shaft 15 may thus be disposed in the opening 11 of the corresponding mounting piece with radial clearance, enabling the support shaft 15 to flex.

The longitudinal axes of the massage members 10 may remain rectilinear when the massage members 10 are not deformable, or they may curve when the massage members 10 are deformable.

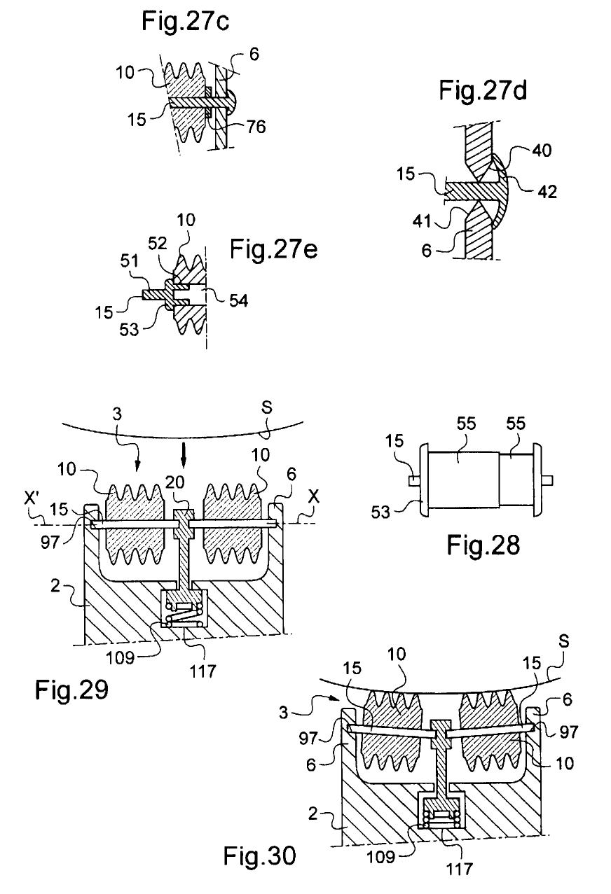

By way of example, FIGS. 27a to 27e show a few possibilities for mounting the end of a support shaft 15 on the corresponding mounting piece 6.

The end of the shaft 15 may be received in a blind housing 30 of the mounting piece 6, as shown in FIG. 27a, the blind housing 30 being suitable for allowing a certain amount of angular movement of the shaft 15 when the position of the intermediate part 20 varies relative to the support 2.

The support shaft 15 may also be engaged in a through opening, as shown in FIG. 27b. Here too, the opening is preferably wide enough to allow sufficient angular movement of the support shaft 15.

At one of its ends, the support shaft 15 may include a retaining element 13 that makes it possible to retain it axially between an mounting piece 6 and the intermediate part 20. By way of example, the retaining elements 13 are fitted parts, but, in a variant, the retaining elements 13 may be formed of portions in relief that are molded or machined integrally with the support shaft 15. The support shaft may also be held in place by at least one part that is fitted on the support 2.

Where appropriate, as shown in FIG. 27c, a washer 76 may be fitted on the support shaft 15 in such a manner as to position the massage member relative to the support shaft 15 so that when the massage member 10 slopes, its end face does not rub against the mounting piece, and the massage member is not hindered in turning.

FIG. 27d shows the possibility of making an opening in which one end of the support shaft 15 is engaged with bevels 40 and 41 in opposite faces of the mounting piece 6, so as to facilitate pivoting of the support shaft 15 relative to its bearing points on the mounting piece 6. This figure also shows the possibility of the support shaft 15 including at least one elastically-deformable retaining member 42 that bears against the outside face of the mounting piece 6, the retaining member 42 being suitable for deforming so as to enable the support shaft 15 to flex.

In general, the massage members may turn on support shafts that do not themselves turn when the massage member turns on being moved in contact with the skin.

In a variant, both the massage members and their support shafts may turn when the massage member is moved over the skin, the support shafts being constrained to turn with the massage members, for example.

The support shaft of a massage member may be a single part that may pass right through the massage member, and that may be received at its ends in the intermediate part and in the corresponding mounting piece.

In a variant, the support shaft of a massage member is made of a plurality of support-shaft segments or stub axles, each segment being fastened to one end of the massage member, for example, as shown in FIG. 27e. In this figure, it can be seen that, at each end of the massage member, the support shaft comprises an endpiece 50 that includes a stub axle 51 that is engaged in the corresponding mounting piece 6 or in the intermediate part 20, and a mounting portion 52 that is engaged in a housing, in particular in a central borehole 54 of the massage member 10, the borehole 54 passing through the massage member from one end to the other, for example. By way of example, the mounting portion 52 is adhesively bonded, force-fitted, snap-fastened, or fastened in some other way on the massage member 10.

Alternatively, the endpieces 50 may be molded onto the massage member 10, e.g. out of a material that is more rigid.

In use, the endpieces 50 may not deform. In a variant, the endpieces 50 may deform. In a preferred embodiment, each endpiece 50 may include a flange 53 that may serve as a spacer so as to avoid the end face of the massage member rubbing against the adjacent mounting piece or against the intermediate part while the massage member is flexing or changing slope.

The use of a fitted support shaft makes it possible to reduce friction between the massage member and the support shaft by selecting materials that have a low coefficient of friction relative to each other.

In a variant not shown, the massage member is molded integrally with stub axles that are engaged in the corresponding mounting piece and in the intermediate part respectively.

The support shaft may be of constant length and may, for example, be driven to a greater or lesser extent into the corresponding housings of the mounting pieces and of the intermediate part, while the intermediate part is moving relative to the support.

In a variant, the support shaft is made to be telescopic, and its length may vary when the slope between the axes of rotation of the massage members varies. By way of example, FIG. 28 shows a telescopic support shaft 15 comprising two stub axles 55 that are hinged respectively to one of the mounting pieces and to the intermediate part. The support shaft 15 may house a return spring that holds the support stub axles 55 in engagement in the corresponding mounting piece and intermediate part. When the position of said intermediate part varies relative to the support, the support shaft 15 may shorten or lengthen.

The intermediate part 20 may be made with various shapes of housing for receiving the support shafts.

In particular, the intermediate part 20 may include a blind housing for receiving the corresponding end of the support shaft in manner similar to that described with reference to FIG. 27a, or it may include a through housing.

The support shafts 15 may have a certain amount of flexibility, so as to be able to flex in order to be put into place between the intermediate part and the corresponding mounting piece of the support.

In a variant, after the support shaft has been put into place, at least one of the housing of the mounting piece and of the intermediate part may be closed by a fitted part for retaining the support shaft on the massage device.

Where appropriate, while the support shaft is being deformed in use, the orientation of the massage portions in relief 12 is modified relative to the orientation at rest, and this change in orientation may produce an additional and progressive massage effect, in particular in a transverse direction to the direction of movement of the massage device.

FIGS. 29 and 30 show an embodiment in which the massage system 3 includes two massage members 4 mounted on two respective support shafts that are connected together in hinged manner by the intermediate part.

Each of the support shafts is engaged, at one end, in a corresponding housing of an mounting piece 6, and at its other end, it is carried by the intermediate part 20 that is movable relative to the support 2 against the action of a resilient return member 109, e.g. constituted by a helical spring that comes to bear against the end 117 of a housing in the support 2.

When pressure is exerted on the rotary massage system 3 by the surface S being treated, the intermediate part 20 may be driven in against the return action of the spring 109, the axes X and X′, e.g. initially in alignment, thus forming an angle between them.

When the pressure ceases, each support shaft 15 may return to its initial configuration, the intermediate part being returned to its initial position by the spring 109.

Naturally, the invention is not limited to the embodiments described above. In particular, the characteristics of the various embodiments shown may be combined with one another within variants that are not shown.

In a variant not shown, the orientation of the axes X and X′ is adjusted by the user, but an elastically-deformable return member is present and may allow the axes X and X′ to move relative to the adjusted position, e.g. to allow a reduction in the angle between the axes X and X′ under the effect of the pressure exerted by the massage members on the skin.

By way of example, the resilient return member is interposed between the knob 23 and the end wall of the housing 25 that receives it, being compressed when pressure is exerted on the massage members.

In variants not shown, the device also may not include a container containing a composition for application to the skin.

The device may also be arranged so as to be fastened on a container containing a composition for application to the skin.

The expression “comprising a” should be understood as being synonymous with “comprising at least one”.

What is claimed is:

1. A massage device including at least one rotary massage system, the device comprising:
a support including two mounting pieces; and
two massage members mounted on said support and each turning relative to the support about an axis of rotation defined by a shaft, each mounting piece supporting the shaft associated with the corresponding massage member, the slope of the axes of rotation relative to the mounting pieces depending on the position of an intermediate part that is movable relative to the support, said intermediate part being situated between the massage members and being connected to the shaft associated with each massage member.

2. A device according to claim 1, the intermediate part being connected to the support other than merely by the shaft of each massage member.

3. A device according to claim 1, the intermediate part being movable relative to the support against the action of a resilient return member.

4. A device according to claim 1, the intermediate part being movable relative to the support in response to the user actuating an adjuster member.

5. A device according to claim 4, the intermediate part including a thread and the adjuster member comprising a knurled knob that is mounted to turn, such that turning the knob causes the intermediate part to move relative to the support.

6. A device according to claim 1, the axes of rotation of the massage members being contained in a single plane when their relative slope a varies.

7. A device according to claim 1, the shafts on which the respective massage members turn being separate from each other, the shafts being hinged at one end to a corresponding mounting piece of the support, and being hinged at the other end to the intermediate part.

8. A device according to claim 1, the angle α between the axes of rotation of the massage members being able to vary by at least 20° because of the movement of the intermediate part relative to the support.

9. A device according to claim 1, including a handle portion.

10. A device according to claim 9, the support being connected in stationary manner to the handle portion.

11. A device according to claim 9, the intermediate part being connected in stationary manner to the handle portion.

12. A device according to claim 1, including a guide portion on which the support is slidably mounted, the guide portion enabling the user to adjust the position of the intermediate part relative to the support.

13. A device according to the preceding claim, including locking means for locking the support in position relative to the guide portion.

14. A device according to claim 1, including a container containing a composition for application to the skin.

15. A device according to the preceding claim, the support being molded integrally with the body of the container.

16. A massage device including at least one rotary massage system, the device comprising:
a support including two mounting pieces;
two massage members mounted on said support and each turning relative to the support about an axis of rotation defined by a shaft, each mounting piece supporting the shaft associated with the corresponding massage member, the slope of the axes of rotation relative to the mounting pieces being linked to the position of an intermediate part that is movable relative to the support, said intermediate part being situated between the massage members and being connected to the shaft associated with each massage member;
a handle portion; and
a container containing a composition for application to the skin, the container defining the handle portion at least in part.

17. A device according to claim 10, the massage system being disposed laterally relative to the handle portion.

18. A device according to claim 1, the massage members being elastically-deformable rollers.

19. A device according to claim 1, at least one of the massage members being mounted on a telescopic shaft.

20. A device according to claim 1, the mounting pieces being made integrally with a base by molding.
